(19) United States
(12) Patent Application Publication
(10) Pub. No.: US 2006/0288630 A1
(43) Pub. Date: Dec. 28, 2006

(54) DEVICE FOR FASTENING FISHING REEL

(76) Inventor: Ming-Yi Lin, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/908,763

(22) Filed: May 25, 2005

(51) Int. Cl. A01K 87/06

(52) U.S. Cl. 43/22

(57) ABSTRACT

A fastening device for a fishing reel (e.g., fly reel) comprises a hollow elongate member including a triangle section which is formed of three lengthwise flats and three lengthwise curved portions each formed between the adjacent flats and three externally threaded extensions respectively extending from the curved portions; a substantially cylindrical fixed sleeve provided at one end, a slot being formed on one side of the inner wall of the fixed sleeve; a movable sleeve provided at the other end which includes an inner portion conformed to the triangle section of the elongate member and adapted to put on a portion of the extensions, and a slot recessed into an inner wall of the inner portion corresponding to the slot of the fixed sleeve; and a plurality of nuts each having a knurled outer surface for screwing the device; whereby the related rotation of the elongate member and the movable sleeve and the sliding of the fishing reel can be prevented.

### BACKGROUND OF THE INVENTION

1. Field of Invention

The present invention relates to fishing equipments and more particularly to a barlike device for fastening a fishing reel (e.g., fly reel) to prevent the fishing reel from sliding.

2. Related Art

A conventional reel (e.g., fly reel) mounted on a fishing rod is cylindrical and comprises a front and rear sleeve with grooves, an axial spool with fishing line wrapped around, and a fastener adapted to releasably secure to the fishing line. The fishing line tends to pull accidentally because the reel tends to slide on the fishing rod since there is no fastening means provided on the circumferential surface of the reel. Thus, a need for improvement exists.

### SUMMARY OF THE INVENTION

It is therefore an object of the present invention to provide a device for fastening a fishing reel.

The above and other objects of the present invention are realized by providing a fastening device comprising a hollow elongate member including a triangle section which is formed of three lengthwise flats and three lengthwise curved portions each formed between the adjacent flats and three externally threaded extensions respectively extending from the curved portions; a substantially cylindrical fixed sleeve provided at one end, a slot being formed on one side of the inner wall of the fixed sleeve; a movable sleeve provided at the other end which includes an inner portion conformed to the triangle section of the elongate member and adapted to put on a portion of the extensions, and a slot recessed into an inner wall of the inner portion corresponding to the slot of the fixed sleeve; and a plurality of nuts each having a knurled outer surface for screwing the device; whereby the related rotation of the elongate member and the movable sleeve and the sliding of the fishing reel can be prevented.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of a device for fastening fishing reel according to the invention;

FIG. 2 is a perspective view of the assembled device secured to a fishing reel; and

FIG. 3 is a side view in part section of FIG. 2.

### DETAILED DESCRIPTION OF THE INVENTION

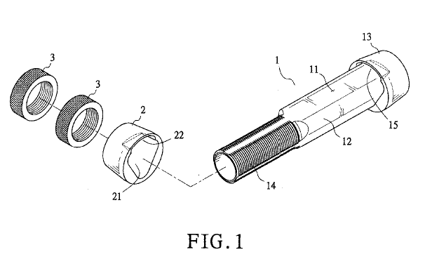

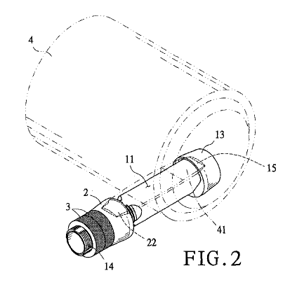

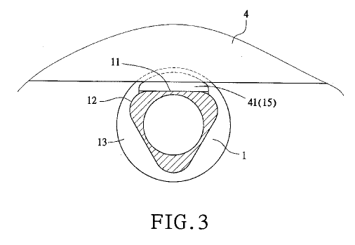

Referring to FIGS. 1, 2, and 3, there are shown a device for fastening a fishing reel (e.g., fly reel) constructed in accordance with a preferred embodiment of the invention. The device comprises a hollow elongate member 1 including a triangle section which is formed of three lengthwise flats 11 and three lengthwise curved portions 12 each formed between the adjacent flats 11. A substantially cylindrical fixed sleeve 13 is provided at one end of the elongate member 1. A slot 15 is formed on one side of the inner wall of the fixed sleeve 13. At the other end of the elongate member 1 forms a cylinder on which three externally threaded extensions 14 respectively extends from the curved portions 12 for securing a movable sleeve 2. A plurality of nuts 3 each has a knurled outer surface. The movable sleeve 2 including an inner portion 21 conformed to the triangle section of the elongate member 1 and adapted to put on a portion of the extensions 14 at the other end of the elongate member 1 and a slot 22 recessed into an inner wall of the portion 21 corresponding to the slot 15 of the fixed sleeve 13.

In assembly, put a fastening piece 41 of a cylindrical fishing reel 4 upon one flat 111 of the elongate member 1, snugly fit one end of the fastening piece 41 into the slot 15 of the fixed sleeve 13. Then, insert the movable sleeve 2 through the extension 14 of the elongate member 1 such that the other end of the fastening piece 41 is inserted into the slot 22 of the movable sleeve 2. Last, screw the nuts 3 onto the extension 14 to fasten both the movable sleeve 2 and the flat member 41. As an end, the fishing reel 4 and the device are fastened together.

In operation, the related rotation of the elongate member 1 and the movable sleeve 2 can be prevented and the slot 22 of the movable sleeve 2 will always be aligned with the slot 15 of the fixed sleeve 13 when the movable sleeve 2 is moved.

While the invention herein disclosed has been described by means of specific embodiments, numerous modifications and variations could be made thereto by those skilled in the art without departing from the scope and spirit of the invention set forth in the claims.

What is claimed is:

1. A device for fastening fishing reel comprising:
a hollow elongate member including a triangle section which is formed of three lengthwise flats and three lengthwise curved portions each formed between the adjacent flats and three externally threaded extensions respectively extending from the curved portions;
a substantially cylindrical fixed sleeve provided at one end, a slot being formed on one side of the inner wall of the fixed sleeve;
a movable sleeve provided at the other end which includes an inner portion conformed to the triangle section of the elongate member and adapted to put on a portion of the extensions, and a slot recessed into an inner wall of the inner portion corresponding to the slot of the fixed sleeve; and
a plurality of nuts each having a knurled outer surface for screwing the device;
whereby the related rotation of the elongate member and the movable sleeve and the sliding of the fishing reel can be prevented.
